(19) United States
(12) Patent Application Publication
(10) Pub. No.: US 2023/0232333 A1
(43) Pub. Date: Jul. 20, 2023

(54) CONTROL METHOD FOR NETWORK DISCONNECTION DURING SCREEN OFF AND MOBILE DEVICE

(71) Applicant: ASUSTeK COMPUTER INC., Taipei (TW)

(72) Inventors: Chieh-Hung Lin, Taipei (TW); Chi-Lung Chen, Taipei (TW); Chih-Hsien Yang, Taipei (TW)

(21) Appl. No.: 17/955,962

(22) Filed: Sep. 29, 2022

(30) Foreign Application Priority Data
Jan. 17, 2022 (TW) 111101909

(51) Int. Cl. H04W 52/02

(52) U.S. Cl. CPC H04W 52/0261; H04W 52/0254

(57) ABSTRACT

The disclosure provides a control method for network disconnection during screen off and a mobile device. The control method is applicable to a mobile device, and includes: setting a network restriction list based on a plurality of applications of the mobile device, where an application run in a background in the applications is excluded from the network restriction list; determining, based on a system status of the mobile device, whether the system status meets a trigger condition, where the trigger condition is that a screen of the mobile device is off for more than a preset time, and there is no external power supply; and starting a network disconnection mechanism when the trigger condition is met, to restrict network connections of the applications in the network restriction list, and maintaining the network connections when the trigger condition is not met.

### CROSS-REFERENCE TO RELATED APPLICATION

This application claims the priority benefit of Taiwan application serial No. 111101909, filed on Jan. 17, 2022. The entirety of the above-mentioned patent application is hereby incorporated by reference herein and made a part of the specification.

### BACKGROUND OF THE INVENTION

### Field of the Invention

The disclosure relates to a control method for network disconnection during screen off and a mobile device for performing the control method.

### Description of the Related Art

With the popularization of mobile devices, the mobile devices are widely used in the life of modern people. A lot of applications are installed on the mobile devices, to satisfy demands of users in various aspects. However, the applications wake the system up from time to time, which increases the power consumption of the system. In addition, as the number of installed applications increases, the power consumption becomes increasingly serious.

### BRIEF SUMMARY OF THE INVENTION

According to the first aspect of the disclosure, a control method for network disconnection during screen off is provided. The control method is applied to a mobile device and includes: setting a network restriction list based on a plurality of applications of the mobile device, where an application run in a background in the applications is excluded from the network restriction list; determining, based on a system status of the mobile device, whether the system status meets a trigger condition, where the trigger condition is that a screen of the mobile device is off for more than a preset time, and there is no external power supply; and starting a network disconnection mechanism when the trigger condition is met, to restrict network connections of the applications in the network restriction list; and maintaining the network connections when the trigger condition is not met.

According to the second aspect of the disclosure, a mobile device including a screen, a power supply unit, a processor, a storage unit, and a firewall is provided. The processor is electrically connected to the screen and the power supply unit. The processor sets a network restriction list based on a plurality of applications of the mobile device, where an application run in a background in the applications is excluded from the network restriction list. The processor determines, based on a system status of the mobile device, whether the system status meets a trigger condition, where the trigger condition is that a screen of the mobile device is off for more than a preset time, and the power supply unit does not have an external power supply. The processor starts a network disconnection mechanism when the trigger condition is met, and maintains the network connections when the trigger condition is not met. The storage unit is electrically connected to the processor, and configured to store the network restriction list and the trigger condition. The firewall is electrically connected to the processor. The firewall restricts the network connections of the applications in the network restriction list according to the network disconnection mechanism.

In conclusion, the disclosure provides a control method for network disconnection during screen off and a mobile device. Applications that are not used are restricted through cooperation between a network restriction list and a network disconnection mechanism without being perceived by a user, thereby effectively controlling power consumption with the least impact and prolonging a use time of the mobile device. Therefore, the disclosure effectively alleviates the problem of power consumption of the mobile device increased by applications and prolongs a standby time, thereby providing good user experience.

### BRIEF DESCRIPTION OF THE DRAWINGS

FIG. 1 is a schematic block diagram of a mobile device according to an embodiment of the disclosure;

FIG. 2 is another schematic block diagram of a mobile device according to an embodiment of the disclosure; and

FIG. 3 is a schematic flowchart of a control method for network disconnection during screen off according to an embodiment of the disclosure.

### DETAILED DESCRIPTION OF THE EMBODIMENTS

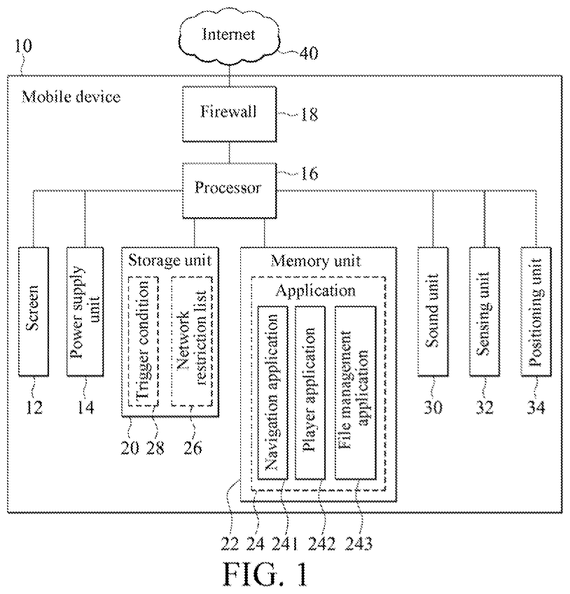

Referring to FIG. 1, a mobile device 10 includes a screen 12, a power supply unit 14, a processor 16, a firewall 18, a storage unit 20, and a memory unit 22. In the mobile device 10, the processor 16 is electrically connected to the screen 12 and the power supply unit 14, to display all pictures through the screen 12 and utilize the power supply unit 14 to supply power required by elements in the mobile device 10. The processor 14 sets a network restriction list 26 based on a plurality of applications 24. An application 24 run in a background in the applications 24 is excluded from the network restriction list 26. The application 24 run in the background may be a navigation application 241, a player application 242, a file management application 243, or any combination thereof. The processor 16 determines, based on a system status, whether the system status meets a trigger condition 28. The trigger condition 28 is that a screen 12 is off for more than a preset time, and the power supply unit 14 does not have an external power supply. In an embodiment, the preset time is 1 minute. The processor 16 starts a network disconnection mechanism when the trigger condition 28 is met and continuously maintains the original network connections when the trigger condition 28 is not met. The firewall 18 is electrically connected to the processor 16 and the Internet 40, and the firewall 18 restricts the network connections between the applications 24 in the network restriction list 26 and the Internet 40 according to the network disconnection mechanism. The storage unit 20 is electrically connected to the processor 16, and configured to store the network restriction list 26 and the trigger condition 28. The memory unit 22 is electrically connected to the processor 16, and configured to store the applications 24.

In an embodiment, the processor 16 is further electrically connected to a sound unit 30, a sensing unit 32, and a positioning unit 34, and configured to monitor the sound unit 30, the sensing unit 32, and the positioning unit 34, and accordingly learn of running statuses of the applications 24. The positioning unit 34 is global positioning system (GPS) unit.

In an embodiment, the processor 16 keeps monitoring the system status after starting the network disconnection mechanism. Once the system status does not meet the trigger condition 28, including at least one of the cases such as that the screen 12 is turned on or that the power supply unit 14 has an external power supply, the processor 16 stops the network disconnection mechanism, that is, instructs the firewall 18 to restore the network connections of the applications 24 in the network restriction list 26.

In an embodiment, in the trigger condition 28, that the power supply unit 14 does not have an external power supply means that the power supply unit 14 is not electrically connected to the mains through a power adapter for charging, or the power supply unit 14 is not electrically connected to a portable power supply for charging.

In an embodiment, the processor 16 updates the network restriction list 26 in the storage unit 20 at any time. In an embodiment, when one of the applications 24 originally run is away from a foreground for an idle time, it means that the application 24 is not run for the idle time. In this case, the application 24 is added to the network restriction list 26. The idle time ranges from 10 seconds to 30 minutes.

In an embodiment, the processor 16 is, but not limited to, a central processing unit (CPU), a microprocessor, a digital signal processor (DSP), an application-specific integrated circuit (ASIC), a system on a chip (SOC), other similar elements or combinations, or the like.

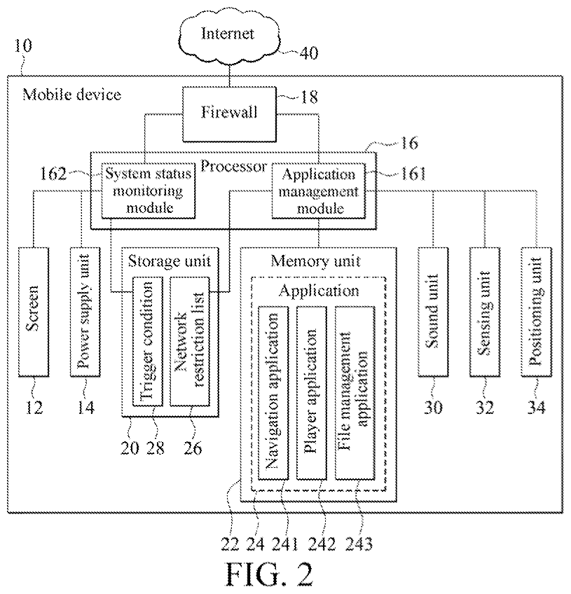

Based on the mobile device 10, the disclosure further describes the basic software architecture of the disclosure from the system architecture of the processor 16 of the mobile device 10. Referring to both FIG. 1 and FIG. 2, the processor 16 further includes an application management module 161 and a system status monitoring module 162. The application management module 161 is electrically connected to the firewall 18, the storage unit 20, the memory unit 22, the sound unit 30, the sensing unit 32, and the positioning unit 34. The application management module 161 monitors the applications 24 and sets or modifies the network restriction list 26. The system status monitoring module 162 is electrically connected to the screen 12, the power supply unit 14, the firewall 18, and the storage unit 20. The system status monitoring module 162 monitors the system status and starts the network disconnection mechanism when the trigger condition 28 is met.

In an embodiment, as shown in FIG. 2, the application management module 161 monitors all the applications 24, including types of the applications 24, times during which the applications 24 are away from the foreground, whether the navigation application 241 is navigating, whether the player application 242 is playing music, whether the file management application 243 is transmitting files, and so on, to determine applications 24 that are not used and applications 24 that are currently used, and further, dynamically set or modify the network restriction list 26 accordingly. Therefore, the network use permissions of the applications 24 are dynamically adjustable. Specifically, after monitoring that an application 24 is away from the foreground for an idle time of 10 seconds to 30 minutes, the application management module 161 adds the application 24 to the network restriction list 26. When the application 24 returns to the foreground for execution, the application management module 161 removes the application 24 from the network restriction list 26. When the navigation application 241 in the applications 24 is away from the foreground for an idle time, but is still navigating, the navigation application 241 is removed from the network restriction list 26 temporarily. Until the navigation ends and the idle time of being away from the foreground is met, the navigation application 241 is added to the network restriction list 26. When the player application 242 in the applications 24 is away from the foreground for an idle time, but is still playing music in the background, the player application 242 is not added in the network restriction list 26 temporarily. Until the music is stopped and the idle time of being away from the foreground is met, the player application 242 is added to the network restriction list 26. When the file management application 243 in the applications 24 is away from the foreground for an idle time, but is still transmitting files in the background, the file management application 243 is not added in the network restriction list 26 temporarily. Until the transmission ends and the idle time of being away from the foreground is met, the file management application 243 is added to the network restriction list 26.

In an embodiment, as shown in FIG. 2, the system status monitoring module 162 monitors the system status of the mobile device 10, including whether the screen 12 is turned on, whether the power supply unit 14 has an external power supply, and so on, to determine the system status, so as to start the network disconnection mechanism or stop the network disconnection mechanism based on the system status. Specifically, when the system status monitoring module 162 detects that the screen 12 is off for more than a preset time and the power supply unit 14 does not have an external power supply, the system status monitoring module 162 starts the network disconnection mechanism, that is starts the network restriction. The firewall 18 restricts the network connections of the applications 24 in the network restriction list 26 according to the network disconnection mechanism, so that the applications 24 in the network restriction list 26 cannot be connected to the Internet 40 for network connection. Therefore, the applications 24 in the network restriction list 26 in the background can be prevented from being automatically started, to avoid unnecessary power consumption.

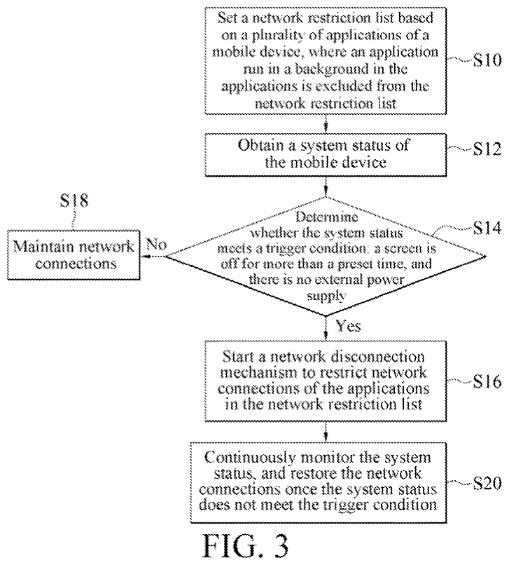

Referring to both FIG. 2 and FIG. 3, when a mobile device 10 performs a control method for network disconnection during screen off, a process thereof is shown in steps S10 to S20. Firstly, as shown in step S10, a processor 16 (an application management module 161) sets a network restriction list 26 based on a plurality of applications 24 installed on the mobile device 10, where an application 24 run in a background in the applications 24 is excluded from the network restriction list 26. The application 24 run in the background includes a navigation application 241, a player application 242, a file management application 243, or any combination thereof. As shown in step S12, the processor 16 detects a system status of the mobile device 10, including a status of a screen 12 and a status of a power supply unit 14, to obtain the system status of the mobile device 10. As shown in step S14, the processor 16 (a system status monitoring module 162) determines, according to the system status of the mobile device 10, whether the system status meets a trigger condition 28. The trigger condition 28 is that the screen 12 of the mobile device 10 is off for more than a preset time and the power supply unit 14 does not have an external power supply. In the step S14, the processor 16 determines whether the screen 12 is turned off for more than the preset time and whether the power supply unit 14 has the external power supply. When the system status meets the trigger condition 28 that the screen 12 is turned off for more than the preset time, and the power supply unit 14 does not have the external power supply, as shown in step S16, the processor 16 starts a network disconnection mechanism and restricts network connections of the applications 24 in the network restriction list 26 through the firewall 18. When the screen 12 is not off for more than the preset time or the power supply unit 14 has an external power supply, which means that the trigger condition 28 is not met, in this case, as shown in step S18, the system status monitoring module 162 does not start the network disconnection mechanism to maintain the network connections. After the step of starting the network disconnection mechanism as shown in step S16, further as shown in step S20, the system status monitoring module 162 continuously monitors the system status of the screen 12 and the power supply unit 14. Once the system status does not meet the trigger condition 28, in an embodiment, the screen 12 is turned on or the power supply unit 14 has an external power supply, the network disconnection mechanism is stopped immediately to restore the network connections.

Definitely, the application management module 161 updates the network restriction list 26 in the storage unit 20 according to the using status of the applications 24 at any time. For this part, reference is made to the foregoing descriptions, and details are not described herein again.

Based on the mobile device 10, the application management module 161 and the system status monitoring module 162 in the processor 16 are implemented on software elements, to implement related functions by using built-in software elements of the processor 16.

In conclusion, the disclosure provides a control method for network disconnection during screen off and a mobile device. Applications that are not used are restricted through cooperation between a network restriction list and a network disconnection mechanism without being perceived by a user, thereby effectively controlling power consumption with the least impact and prolonging a use time of the mobile device. Therefore, the disclosure effectively alleviates the problem of power consumption of the mobile device increased by applications and prolongs a standby time, thereby providing good user experience.

The foregoing embodiments are merely for describing the technical ideas and the characteristics of the disclosure, and are intended to enable a person skilled in the art to understand and hereby implement the content of the disclosure. However, the scope of claims of the disclosure is not limited thereto. In other words, equivalent changes or modifications made according to the spirit disclosed in the disclosure shall still fall into scope of the claims of the disclosure.

What is claimed is:

1. A control method for network disconnection during screen off, applicable to a mobile device, the control method comprising:
setting a network restriction list based on a plurality of applications of the mobile device, wherein an application run in a background in the applications is excluded from the network restriction list;
determining, based on a system status of the mobile device, whether the system status meets a trigger condition, wherein the trigger condition is that a screen of the mobile device is off for more than a preset time, and there is no external power supply;
starting a network disconnection mechanism when the trigger condition is met, to restrict network connections of the applications in the network restriction list; and
maintaining the network connections when the trigger condition is not met.

2. The control method for network disconnection during screen off according to claim 1, wherein after the step of starting a network disconnection mechanism when the trigger condition is met, the method further comprises: monitoring the system status and restoring the network connections once the system status does not meet the trigger condition.

3. The control method for network disconnection during screen off according to claim 2, wherein a case that the system status does not meet the trigger condition is that the screen is turned on or there is an external power supply.

4. The control method for network disconnection during screen off according to claim 1, wherein after at least one of the applications is away from a foreground for an idle time, the application is added to the network restriction list.

5. The control method for network disconnection during screen off according to claim 4, wherein the idle time ranges from 10 seconds to 30 minutes.

6. The control method for network disconnection during screen off according to claim 1, wherein the application run in the background is a navigation application, a player application, a file management application, or any combination thereof.

7. The control method for network disconnection during screen off according to claim 1, wherein when running of the application run in the background is stopped, the application is added to the network restriction list.

8. The control method for network disconnection during screen off according to claim 1, wherein the preset time is 1 minute.

9. A mobile device, comprising:
a screen;
a power supply unit;
a processor, electrically connected to the screen and the power supply unit, wherein the processor sets a network restriction list based on a plurality of applications of the mobile device, wherein an application run in a background in the applications is excluded from the network restriction list, the processor determines, based on a system status of the mobile device, whether the system status meets a trigger condition, wherein the trigger condition is that a screen of the mobile device is off for more than a preset time, and the power supply unit does not have an external power supply; and the processor starts a network disconnection mechanism when the trigger condition is met, and maintains the network connections when the trigger condition is not met;
a storage unit, electrically connected to the processor, and configured to store the network restriction list and the trigger condition; and
a firewall, electronically connected to the processor, wherein the firewall restricts network connections of the applications in the network restriction list according to the network disconnection mechanism.

10. The mobile device according to claim 9, wherein the processor monitors the system status after starting the network disconnection mechanism, and restores the network connections once the system status does not meet the trigger condition.

11. The mobile device according to claim 10, wherein a case that the system status does not meet the trigger condition is that the screen is turned on or there is an external power supply.

12. The mobile device according to claim 9, wherein after at least one of the applications is away from a foreground for an idle time, the application is added to the network restriction list.

13. The mobile device according to claim 12, wherein the idle time ranges from 10 seconds to 30 minutes.

14. The mobile device according to claim 9, wherein the application run in the background is a navigation application, a player application, a file management application, or any combination thereof.

15. The mobile device according to claim 9, wherein when running of the application run in the background is stopped, the application is added into the network restriction list.

16. The mobile device according to claim 9, wherein the preset time is 1 minute.

17. The mobile device according to claim 9, further comprising a memory unit, electrically connected to the processor, and configured to store the applications.

18. The mobile device according to claim 17, wherein the processor further comprises:
an application management module, electrically connected to the storage unit, the firewall, and the memory unit, and configured to monitor the applications and set the network restriction list; and
a system status monitoring module, electrically connected to the screen, the power supply unit, the storage unit, and the firewall, wherein the system status monitoring module monitors the system status, and starts the network disconnection mechanism when the trigger condition is met.

19. The mobile device according to claim 18, wherein the application management module is further electrically connected to a sound unit, a sensing unit and a positioning unit, wherein the application management module monitors the sound unit, the sensing unit and the positioning unit.
